(19) United States
(12) Patent Application Publication
(10) Pub. No.: US 2024/0286271 A1
(43) Pub. Date: Aug. 29, 2024

(54) TRUNK EXOSKELETON WITH A MECHANICAL COUPLING ASSEMBLY FOR ACTIVATING/DEACTIVATING ASSISTANCE

(71) Applicant: HUMAN MECHANICAL TECHNOLOGIES, TARBES (FR)

(72) Inventor: Simon MASSONNIER, TARBES (FR)

(21) Appl. No.: 18/570,766

(22) PCT Filed: Jun. 14, 2022
(86) PCT No.: PCT/FR2022/051134

§ 371 Date: Dec. 15, 2023

(30) Foreign Application Priority Data
Jun. 15, 2022 (FR) 2106332

(51) Int. Cl. B25J 9/00; A61H 3/00

(52) U.S. Cl. CPC B25J 9/0006; A61H 3/008; A61H 2201/1652

(57) ABSTRACT

An exoskeleton including a pair of lower modules connected to an upper portion by pivot points, an elastic actuator configured to exert, when tensioned, a compensatory force moment, a mechanical coupling assembly configured: —in a working position of the user, to tension the at least one elastic actuator when the lower modules form substantially the same non-zero angle with the upper portion, the exoskeleton then providing assistance, —in a walking position of the user, to enable a counter-phase free pivoting of the lower modules, without the exoskeleton providing assistance, the coupling assembly including a flexible connecting element coupling the lower modules together, and a flexible guide element of the connecting element, coupling the lower modules to the upper portion via the connecting element.

### CROSS REFERENCE TO RELATED APPLICATIONS

This application is a National Stage of International Application No. PCT/FR2022/051134, having an International Filing Date of 14 Jun. 2022, which designated the United States of America, and which International Application was published under PCT Article 21(2) as WO Publication No. 2022/263762 A1, which claims priority from and the benefit of French Patent Application No. 2106332 filed on 15 Jun. 2021, the disclosures of which are incorporated herein by reference in their entireties.

### BACKGROUND

### Field

The field of the disclosure is that of exoskeletons, i.e. mechanical structures which partially duplicates the human skeleton in order to assist it in carrying out a task or an activity, such as raising and carrying a load, or performing repetitive movements.

By “load”, it should be understood in this text a weight supported by a user, i.e. the weight of a portion of his/her own body possibly added to the weight or a force exerted by one or more object(s) handled by the user.

More specifically, the disclosure relates to a trunk exoskeleton with a mechanical coupling assembly for assistance activation/deactivation.

In particular, the disclosure finds applications in the field of logistics, and more generally in fields in which a user is required to raise loads from a low point, requiring leaning the torso downwards, then raising it, and vice versa.

### Brief Description of Related Developments

Trunk exoskeleton techniques are known from the prior art, allowing relieving their user in particular when raising loads, handling objects located proximate to the ground, or when carrying out repetitive tasks requiring leaning and standing up frequently.

Such activities place heavy demands on the body of the user, particularly in the lumbar region, and promote the apparition of musculoskeletal disorders (known by the abbreviation “MSD”), which has given rise to a need for such trunk exoskeleton techniques.

In particular, exoskeleton techniques are known having a top portion in connection with the trunk of a user, and a bottom portion in connection with each of the lower limbs of the user, the two parts pivoting relative to one another, the pivot point generally being located at the hips of the user. In order to provide assistance to the user leaning downwards, a torque is exerted at the pivot point, in an active manner by means of a motor for example, or in a passive manner by an elastic energy storage element, such as a spring for example. According to some variants, the connection between the top portion and the bottom portion is made by a flexible blade, which serves both as a connecting element and as an energy storage element.

A major drawback of active assistance exoskeletons is their low autonomy, due to a limited energy, often electrical energy, storage capacity as well as their large weight, due to actuators and batteries which are in general particularly heavy.

Another major drawback of the aforementioned techniques, in particular passive assistance techniques, is the immediate activation of the assistance, as soon as the lower limbs of the user are no longer aligned with his/her trunk. Thus, even during movements or positions requiring no assistance, such as walking, the user works unnecessarily against the elastic element, resulting in a great discomfort and even in muscular exhaustion.

Faced with these problems, known exoskeleton techniques have been improved, by providing systems enabling swinging of the trunk in a limited angular range around the vertical, before activating assistance when the user leans further. According to some variants, such an angular range can be adjusted by the user, depending on his/her needs.

Nonetheless, these techniques are not fully satisfactory, to the extent that they do not differentiate between movements requiring assistance, such as a downward swinging of the trunk, and those requiring no assistance, such as walking. In addition, to enable unhindered walking, the angular range of inactivation should be relatively large, with the drawback that no assistance is possible in this range even though it would be necessary. The adjustment of said range by the user is a particularly tedious solution which cannot be used dynamically and at high frequency.

Other techniques offer options allowing partially overcoming these problems, such as locking the assistance when it is needed, and unlocking it when it is not needed, enabling the user to walk without the assistance being activated.

Nevertheless, these techniques require frequent handling of the exoskeleton, which has the drawback of being particularly tedious and time-consuming, in particular when the user quickly goes through movement phases requiring assistance and other phases where assistance is not necessary. In addition, the risk that the user forgets to perform unlocking or locking is considerable, resulting in annoyance and disinterest of the user with regards to the system.

An important need that a system providing a solution to the problems set out hereinabove should address is to be easily adaptable to any user type. In particular, the exoskeleton solution should be usable by users of different ages, genders and morphologies without requiring considerable modifications or adjustments.

None of the current systems allows simultaneously addressing all of the required needs, namely providing a trunk exoskeleton technique which is light and simple in design, which is quick and simple to put on for a user while being simple to adapt to the latter, and which provides assistance only when the user requires it, without having to actively intervene.

### SUMMARY

The present disclosure aims to overcome all or part of the aforementioned drawbacks of the prior art.

To this end, the disclosure relates to a trunk exoskeleton including:
an upper portion able to be attached to the trunk of the user of the exoskeleton,
a pair of lower modules each being able to be attached to a lower limb of the user, each lower module being connected to the upper portion by a distinct pivot point located at the height of the hips of the user,
at least one elastic actuator configured, when tensioned, to exert a compensatory force moment on the trunk of the user,
a mechanical coupling assembly configured:
in a working posture of the user, to tension the at least one elastic actuator when the lower modules form substantially the same non-zero angle with the upper portion, the exoskeleton then providing assistance, and
in a walking posture of the user, to enable a counter-phase free pivoting of the lower modules, without the exoskeleton providing assistance.

Thus, the exoskeleton primarily consists of three main portions, namely the upper portion attached to the trunk, and the lower modules attached to the lower limbs, which can pivot about the pivot points. It should be understood that in this manner, these three main portions partially duplicate the skeleton of the user, and are hinged substantially at the same level as the skeleton of the user, namely at the pelvic joint. It is specified that the position of a pivot point is configured to be positioned with respect to the joint between the lower limb and the hip of the user, in order to disturb as little as possible the walk of the user. In general, such a position corresponds to an “anatomical” pivot point between the trunk and the lower limbs.

Thanks to the elastic actuator, a compensatory force moment can be exerted on the trunk of the user, so as to assist him/her during an upward movement of the trunk, when he/she raises his/her bust. It should be understood that the compensatory force moment is exerted “upwards”, i.e. it tends to help the user to get up, and at least allows countering the moment exerted by the user on the exoskeleton, when raising a load off the ground for example. The elastic actuator may be in various forms, as will be seen hereafter, and works when it is tensioned, it being understood that the expression “tensioned” refers to an elastic actuator on which a force, whether a tensile and/or compressive force, is exerted. This “tensioned” state is opposed to the “relaxed” state of the actuator, in which substantially no force is exerted on the latter.

Furthermore, the coupling assembly includes:
a connecting element coupling the lower modules together,
a guide element of the connecting element, fastened to the upper portion, coupling the lower modules to the upper portion via the connecting element,
the connecting element and the guide element being flexible.

The exoskeleton can take on at least two distinct characteristic states, depending on the posture of the user.

When the user is in a working posture, i.e. when his/her lower limbs form substantially the same angle with his/her trunk, the exoskeleton is in an “active” state. The potential energy of the downward movement of the trunk of the user is stored in the form of elastic energy in the elastic actuator. This effect is obtained by the presence of the mechanical coupling assembly, the connecting element of which attaches the lower modules, being fastened by each of its ends to one of the lower modules, the connecting element in turn following the rotation of the upper portion, being driven by the guide element secured to the upper portion. The elastic actuator is arranged so as to be tensioned when the connecting element is driven by the guide element, in a working posture. In this manner, the exoskeleton “detects” a working position, resulting in a storage of elastic energy in the elastic actuator(s), to be recovered when the user raises his/her trunk.

When the user is in a walking posture, i.e. when his/her lower limbs perform a swinging or pendulum movement, alternating or in counter-phase, with respect to his/her trunk, the exoskeleton is in an “inactive” state. In this state, the connecting element can move freely in the guide element, which consequently avoids tensioning the elastic members. Indeed, although there is a relative movement between the upper portion and a lower module, the connecting element is not driven by the guide element in this configuration because the alternating movement of the lower modules enables movement thereof in/on the guide element. Since the elastic actuator is arranged so as to be tensioned when the connecting element is driven by the guide element, it should be understood that when the connecting element is not driven, in a walking posture, then the elastic actuator is relaxed. In this manner, substantially no kinetic energy (originating from the walk of the user) is stored in the form of elastic energy in the exoskeleton when walking.

To sum up, the aforementioned effects are obtained by the fact that the mechanical coupling assembly comprises two distinct elements, the connecting element being able to move freely in the guide element, avoiding any activation of the exoskeleton when walking, and the guide element driving the connecting element when the trunk is leaning forwards, thereby activating the exoskeleton by tensioning the elastic actuator(s).

Furthermore, the flexible nature of the connecting element and of the guide element is particularly advantageous with regards to adaptability of the exoskeleton to different morphologies of users, of various ages and genders. Indeed, the mechanical coupling between the right and left portions of the exoskeleton is generally done in a rigid manner on the exoskeletons of prior art, making a width adjustment difficult and even impossible. According to the present disclosure, the flexible nature, also described as “flexible”, of the coupling assembly, allows adapting the exoskeleton to various waist circumferences, without requiring any adjustment. In other words, the exoskeleton according to the disclosure does not have a predefined standard width, but on the contrary a multitude of different widths, extending up to the limit authorised by the length of the coupling assembly. In addition, such a design has the advantage of not absorbing any external force, unlike a rigid structure which would then have to be sized so as to resist shocks over time, which would imply that the exoskeleton is larger and heavier. Finally, such a flexible design allows arranging the coupling assembly the closest to the body of the user, according to an arrangement adapted to his/her morphology, while avoiding any risk of collision between the body of the user and the exoskeleton.

According to a preferred variant, said flexible connecting element is an elongate element substantially with no elastic deformation capacity, and wherein said flexible guide element is a substantially incompressible elongate element.

In this manner, the connecting element can reliably fill its coupling role, unable to be elastically deformed when a tensile force is exerted thereon. Indeed, the connecting element should be able to transmit a force in an active state, in order to tension the elastic actuator, which would prove impossible if the connecting element substantially deforms elastically. At the same time, according to a series of implementation variants, the guide element should be substantially incompressible, in order not to deform when a tensile force is exerted on the connecting element, which would also have the effect of making it impossible to tension the elastic actuator in an active state.

In addition, the elongate and flexible nature of the connecting element allows connecting the two sides of the exoskeleton according to an advantageously selected route, such as an arc on the back of the user. Such an element may also move simply and with no constraint in a corresponding guide element, which defines the route followed by the connecting element.

According to an advantageous variant, said flexible connecting element is a cable, and the flexible guide element is a sheath with a diameter adapted to accommodate said cable.

In this manner, the mechanical coupling assembly is made in a particularly simple manner, using components commonly available in the market, allowing limiting the manufacturing and repair cost of the exoskeleton. For example, a standard sheath is composed of an external sheath made of plastic which serves as a protection, and a sheath consisting of a spiral steel wire which guarantees incompressibility while preserving some softness and flexibility. Indeed, a guide element that is too elastic would have the effect of being compressed when the connecting element is tensioned, which would not enable the coupling assembly to fill its function as described before. As regards the connecting element, the use of a standard cable, for example metallic, of the “Bowden” type is a preferred option, featuring a substantial strength and being flexible while remaining substantially with no elastic deformation capacity.

Nonetheless, other variants may be considered, such as a connecting element made by a flexible strip, chain, etc. In turn, the guide element may also be a rigid element having a predefined shape, according to one variant.

According to a particular variant, the upper portion comprises a pair of support masts, each support mast including on a lower end a fastening point of said guide element, and being connected to said corresponding pivot point at said lower end, and including at an upper end a means for connection to the trunk of the user.

Thus, the upper portion consists of particularly simple elements, mainly allowing applying the compensatory force moment to the trunk of the user. In particular, the masts may be in the form of rods, tubes, blades or any other suitable elongate element. It is possible to provide for support masts adjustable in length, by means of rods inserted and adjustable in tubes forming the bottom portion of the upper portion, so as to make the exoskeleton adaptable to different trunk morphologies. Preferably, the support masts are made of metal, or plastic, or a composite material, or any other suitable material.

More particularly, in the context of a first aspect, the lower end may be bent so as to form a substantially transverse arm, and the fastening point of said guide element being located on said substantially transverse arm, the mast being connected to said pivot point at said elbow of the lower end.

According to one variant, the elbow of the lower end includes a yoke oriented towards the corresponding lower module and accommodating an axis forming said pivot point, said connecting rod and said support rod of the lower module being fitted onto said axis. It should be understood that the support mast of an upper module may be made from a plurality of parts, in particular at the bent end.

In this manner, a particularly compact arrangement of the exoskeleton is obtained, all of the parts movable in rotation that are essential to the operation of the exoskeleton being pivotable about the same axis. More particularly, such a design is advantageous with regards to mounting of the exoskeleton, since fastening of the parts around said axis forms almost the only important step in mounting the exoskeleton.

According to an advantageous variant, the exoskeleton includes a pelvic belt fastened at said pivot points.

Such a belt enables holding of the exoskeleton in position on the user, and allows centring the pivot points around the anatomical pivot point of the trunk of the user, so that the compensatory moment is optimally applied. It is also possible to consider any variant forming a support point at the pelvis or buttocks of the user, in order to “centre” the exoskeleton around the anatomical pivot point located at the hips of the user. Advantageously, such a belt is made of a textile material, conferring flexibility on the assembly, adjustable in circumference, and can be padded for more comfort.

According to one variant, the upper portion is formed of two independent upper modules coupled by said guide element.

A major advantage of such a design, in combination with the flexible nature of the coupling assembly, consists in obtaining an exoskeleton composed of two substantially symmetrical portions, connected by flexible elements. It should be understood that in this manner, the exoskeleton adapts perfectly in width to different user morphologies, without requiring any adjustment, the connecting and guide elements naturally adapting to the width thanks to their flexible nature. In such a variant, the two halves of the exoskeleton are advantageously, yet not necessarily, connected by other flexible elements such as a pelvic belt and/or a trunk harness for a better positioning of the exoskeleton on the user. Finally, a two-module design of the upper portion improves the torsional behaviour of the exoskeleton, the user thus feeling no discomfort from the exoskeleton during his/her trunk torsion movements, the left and right halves not being rigidly connected to each other.

In addition, such an arrangement allows designing the exoskeleton in the form of generally elongate right and left two portions. Thus, the exoskeleton is made primarily of four modules, each preferably formed of elongate elements, which results in a very small size when the exoskeleton is stored or transported.

According to a complementary variant, said upper modules are attached to the trunk of the user by means of a harness connecting the independent upper modules, the harness being U-shaped wherein the branches rest on the shoulders of the user and are connected at the back of the user.

Such a harness allows connecting the two upper modules while attaching the upper portion of the exoskeleton to the trunk of the user, while being compact for the user. Advantageously, the harness is provided with adjustment elements, such as buckles, which enables the exoskeleton to adapt in width to different morphologies. Advantageously, such a harness is made of a textile material, conferring flexibility on the assembly, and may be padded for more comfort. Such a harness is particularly advantageous in a design of the upper portion involving two upper modules, nonetheless it should be noted that such a harness may also be used in the context of an upper portion made integrally in one-piece.

According to a particular aspect, each lower module including an elastic actuator, and each lower module comprises a support mast connected by an upper end to said pivot point, and including at a lower end a means for connection to a lower limb of the user, a lever arm element pivotably mounted on said pivot point by a first end, and a second end of which is connected to the connecting element, and said elastic actuator of a lower module is a member loaded in tension, extending between the second end of the lever arm element and the lower end of said support mast of the lower module.

In this manner, each lower module cleverly consists of three simple elements, attached on the one hand to the lower limb of the user, and on the other hand to the pivot point. In such a structure, the support mast serves as an element that duplicates the skeleton of the user, the mast substantially following the thigh of the lower limb of the user. For example, the support mast is a metal, plastic, composite rod, etc., substantially non-deformable and rigid, so as not to deform when the elastic actuator is tensioned. It should be understood that in such an aspect, the support masts of the upper portion transmit the compensatory force moment to the user and are therefore relatively rigid, so as not to deform under the effect of the moments being applied thereon.

In such an aspect, the connecting element is attached to the lever arm elements, which are themselves attached to the elastic actuator. When in an active state, the connecting element is driven by the guide element, thereby driving the lever arm element in rotation, the elastic actuator loaded in tension stretches and stores elastic energy. It should be also understood that, in the inactive state, the lever arm elements can pivot freely in counter-phase, like the lower modules relative to the upper portion, causing no tensioning of the elastic actuator.

According to a variant of this aspect, the elastic member of a lower module is selected from among: an elastic cable, an elastic strap, a coil spring, a gas spring, a hydraulic spring.

According to a preferred variant, the elastic member is a cable or an elastic strap including an elastic core, preferably made of rubber, and a protective sheath, preferably made of a woven material having a deformation capacity.

Thus, it is possible to store potential energy in the form of elastic energy in a particularly simple element, commonly available in the market, inexpensive and which can be easily replaced in the event of wear. For example, such a cable may be found under the name of “Sandow” strap/cable.

According to another particular aspect, the exoskeleton includes two elastic actuators, wherein
each lower module comprises a support mast connected by an upper end to said pivot point, and including at a lower end a means for connection to a lower limb of the user,
each end of the connecting element directly connects the support mast of a lower module,
and wherein each pair of lower module support mast-upper module support mast forms an elastic actuator loaded in bending in said working posture.

According to a particular variant, said support masts of the lower and upper modules consist of flexible rods made of a composite material.

Thus, this alternative aspect allows making the at least one elastic actuator directly from the support masts of a lower module and an upper module attached by a pivot point. In other words, the support masts have a dual function as a structural support element and as an elastic actuator. It should be understood that in such a case, the support masts are elastically deformable, and have a bending modulus selected so as to exert a satisfactory biasing force on the trunk of the user. This force generates a compensatory force moment around the pelvis of the user. In order to achieve this function, the support masts can for example consist of flexible rods made of a composite material such as fiberglass, or any other material allowing obtaining the desired behaviour.

In other words, the support masts of a lower module and of an upper module together form an elastic actuator loaded in bending, like a leaf spring.

The function filled by the coupling assembly is herein identical to that filled in the aspect described further before, the counter-phase free pivoting in a walking posture “separating” the elastic actuator into two portions (connected by the pivot point), leaving the latter substantially relaxed. Driving the connecting element by the guide element in a working posture “locks” the support masts, which become substantially aligned, and form an elastic actuator behaving like one single part, i.e. like a leaf spring type spring.

It should be understood that in such an alternative aspect, the coupling assembly is modified only slightly, with regards to the points for fastening thereof on the lower modules, nonetheless the operating principle remaining unchanged. Only the elastic actuator is made in a different and particularly clever manner, thanks to the dual function of the support masts. Such an aspect also has major advantages in terms of simplicity of design, assembly, and in terms of cost reduction.

According to an advantageous variant, the exoskeleton further includes a declutching device, configured to couple/uncouple a lower module from the mechanical coupling assembly.

Thanks to such a device, it is possible to completely deactivate the exoskeleton when the user wishes so. In such a state, the user can assume postures such as the sitting position without being hampered in his/her movements.

According to a particular aspect, said declutching device includes:
a connecting rod pivotably arranged on said lower module, said connecting rod being connected to the connecting element, and
a declutching latch, allowing blocking or unblocking the pivoting of said connecting rod relative to the lower module,
so as to couple or uncouple said mechanical coupling assembly from said lower module,

Thus, a compact declutching device is obtained, cleverly integrated into the lower module.

In the context of the first alternative aspect involving a lever arm on the lower module, the connecting rod is advantageously pivotably arranged on the lever arm. In this case, the declutching device may be pre-mounted on the lever arm element, which has the effect of not increasing the complexity of mounting the exoskeleton in its entirety.

In the context of the second alternative aspect involving an elastic actuator formed by the support masts, the connecting rod may be pivotably arranged on the upper end of the support mast of the lower module, so as to project transversely from said mast, and could be locked in a projecting position in the active state, in a working posture.

According to another aspect distinct from the aforementioned aspects, the guide element is compressible, and forms an elastic actuator loaded in compression in said working posture.

In such an aspect, it is the guide element which actually fills a dual function of a guidance for the connecting element and of an elastic actuator, allowing simplifying the exoskeleton and reducing the manufacturing costs.

### BRIEF DESCRIPTION OF THE FIGURES

Other advantages, aims and particular features of the present disclosure will appear from the following non-limiting description of at least one particular aspect of the devices and methods objects of the present disclosure, with reference to the appended drawings, wherein:

FIG. 1 is a schematic perspective view of a first aspect of the exoskeleton, worn by a user, the latter being in an inactive position, exoskeleton providing no assistance,

FIG. 2 is a schematic perspective view of the exoskeleton in [FIG. 1], worn by a user, the latter being in a working position, the exoskeleton providing assistance, being in an “active” state

FIG. 3 is a schematic perspective view of the exoskeleton of [FIG. 1], worn by a user, the latter being in a walking position, the exoskeleton providing no assistance, being in an “inactive” state,

FIG. 4 is a schematic view of the left modules and the right modules side-by-side, in a sagittal plane of the exoskeleton, in an active state in the illustration (a) and in an inactive state in the illustration (b),

FIG. 5 is a schematic view of the right side of the exoskeleton, the coupling assembly being shown partially,

FIG. 6 is a schematic back view of the exoskeleton, in an inactive state in the illustrations (a)-(c), the user being in a walking posture, and in an inactive state in the illustrations (d)-(f), the user being in a working posture,

FIG. 7 is a detailed perspective view of the right side of the exoskeleton,

FIG. 8 is a detailed side view of the right side of the exoskeleton,

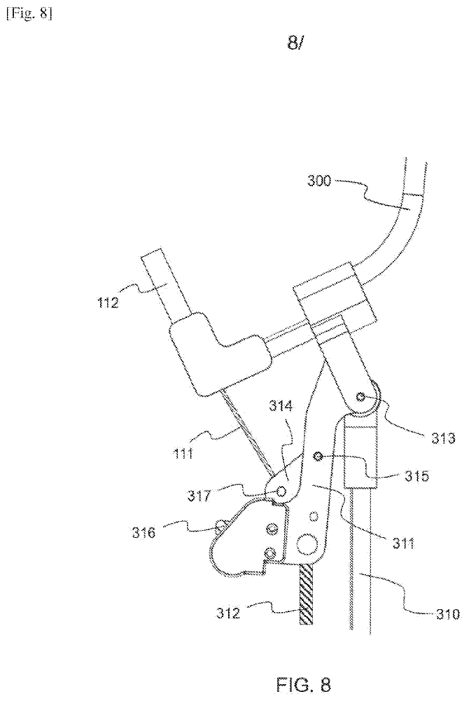

FIG. 9 is a detailed side view of the right side of the exoskeleton, in a section revealing the declutching device

FIG. 10 is a detailed perspective view of the lever arm element, some elements of which have been hidden to reveal the declutching device.

FIG. 11 is a schematic perspective view of a second aspect of the exoskeleton, worn by a user, the latter being in an inactive position, the exoskeleton providing no assistance,

FIG. 12 is a schematic perspective view of the exoskeleton of [FIG. 11], worn by a user, the latter being in a working position, the exoskeleton providing assistance, being in an “active” state

FIG. 13 is a schematic perspective view of the exoskeleton of [FIG. 11], worn by a user, the latter being in a walking position, the exoskeleton providing no assistance, being in an “inactive” state,

### DETAILED DESCRIPTION

The present description is given without limitation, each feature of an aspect could be advantageously combined with any other feature of any other aspect.

As of now, it should be noted that the figures are not plotted to scale.

### Example of a First Particular Aspect

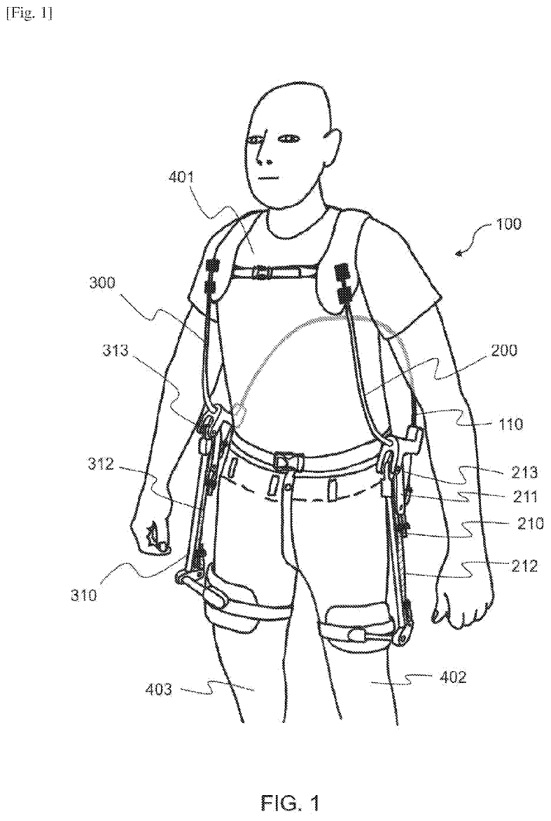

FIG. 1 shows a user wearing a trunk exoskeleton 100 according to a first aspect, in a resting state, in which the exoskeleton is in an “inactive” state and does not provide any assistance to the user.

The trunk exoskeleton 100 is substantially symmetrical with respect to the sagittal plane of the user (corresponding to a sagittal plane of the exoskeleton 100) and has a left portion including an upper module 200 and a lower module 210, and a right portion including an upper module 300 and a lower module 310. The upper modules are attached to the trunk 401 of the user, whereas the lower modules are respectively attached to a lower limb 402, respectively 403, of the user. The upper modules 200 and 300 form an upper portion generally following the same orientation, namely that of the trunk 401, and may also be considered in a single-piece design.

For each left and right portion, the upper modules 200, respectively 300, are connected to the lower modules 210, respectively 310, by a pivot connection about a pivot point 213, respectively 313, located substantially at the hips of the user. In other words, the pivot points 213 and 313 of the left and right portion are located on a transverse axis of the user, corresponding to the axis about which the trunk 401 pivots when the user tilts the latter.

In addition, the right and left portions of the exoskeleton are connected together via a transverse connecting element, such as a pelvic belt described hereinbelow, so as to centre the exoskeleton at the anatomical pivot point of the trunk 401 with the lower limbs 402 and 403.

The exoskeleton 100 is configured so as to provide assistance to the user when the latter tilts his/her trunk 401 forwards, by providing a compensatory force moment directed against the forward tilting movement, said moment being exerted on the trunk of the user, around the pivot points 213 and 313.

The previously-described kinematics allow defining several relative positions between the modules of the exoskeleton 100.

First of all, the upper modules 200 and 300 follow the movements of the trunk 401 of the user, and are thus at all times substantially parallel, and do not form an angle therebetween in a sagittal plane of the exoskeleton 100.

The lower modules 210 and 310 are respectively attached to a lower limb 402, 403 of the user. Thus, the lower modules 210 and 310 can not only form an angle with the trunk 401, but also form an angle therebetween, in a sagittal plane of the exoskeleton.

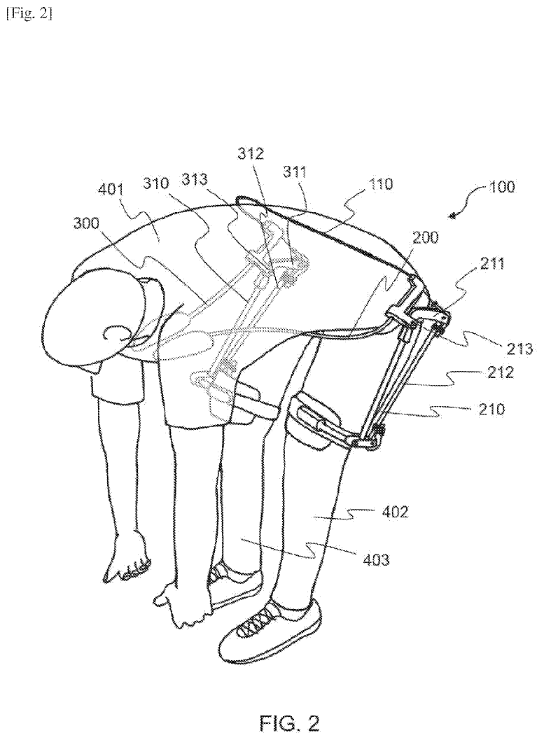

FIG. 2 illustrates a position of the user in which the lower modules 210 and 310 form substantially the same angle with the trunk 401, in a sagittal plane. This position corresponds to a position in which the user raises an object off the ground, for example, and in which assistance is provided.

It should be noticed herein that the concept of “substantially the same angle” covers angles between the lower modules and the trunk, even when slightly different. In other words, there is a tolerance on the working posture, a shift between the lower modules being tolerated even for an optimum use of the exoskeleton. Similarly, the concept of counter-phase includes a tolerance range, which could be more or less substantial, in which the exoskeleton provides no, or very little, assistance. In addition, in any case, the exoskeleton is functional in all positions that are not characteristic positions of the working or walking posture, nonetheless with an assistance that could be less optimum.

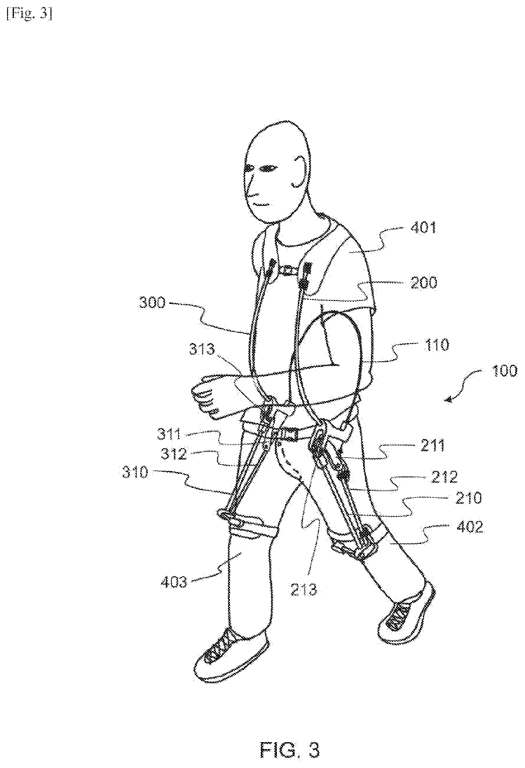

FIG. 3 illustrates a position of the user in which the lower modules 210 and 310 form opposite angles with the trunk 401, in a sagittal plane. This position corresponds to a position in which the user walks, and in which no assistance is provided. Such a position also corresponds to a situation in which the lower modules 210 and 310 pivot in counter-phase, according to a pendulum movement or according to an alternating swinging movement.

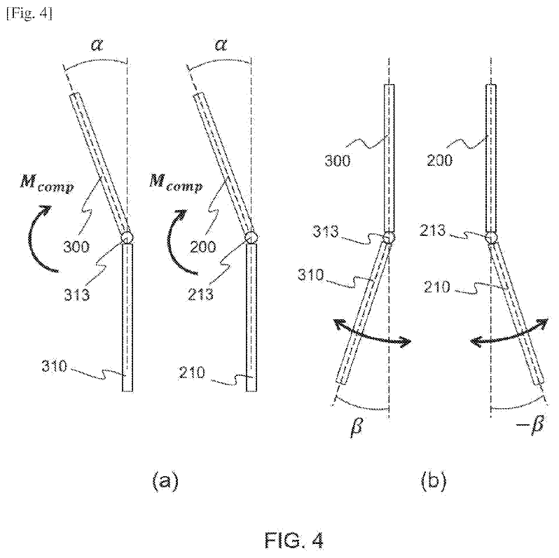

FIG. 4 schematically shows the left modules and the right modules side-by-side, in a sagittal plane of the exoskeleton 100. In the illustration (a), corresponding to the position of FIG. 2, the upper 200 and lower 210 modules on the left side, and the upper 300 and lower 310 modules on the right side, form substantially the same angle α therebetween. The illustration (b) corresponds to an instantaneous view of a relative counter-phase pivoting of the upper 200 and lower 210 modules, and of the upper 300 and lower 310 modules. Such a counter-phase pivoting (illustrated by the double arrows in bold) corresponds to a walking situation of the user, when the lower limbs 402 and 403 tilt in counter-phase around the trunk 401 of the user, as illustrated in FIG. 3. According to another point of view, this state may be defined by the fact that the upper 300 and lower 310 modules on the right side form an obtuse oriented angle β therebetween, and the upper 200 and lower 210 modules on the left side form an obtuse oriented angle −β therebetween. In other words, the formed oriented angles are opposite, i.e. have the same module but with opposite signs. During the pivoting movement, the value of the angle varies, but remains substantially identical for the right and left modules, the sign alternating. It is useful to notice that, in general, the upper modules are substantially vertical when the lower modules pivot in counter-phase, corresponding to the natural walking position of the user.

To sum up, in the position of the illustration (a), corresponding to an active state of the exoskeleton, a compensatory force moment M_{comp} is applied on the upper modules, whereas in the (dynamic) position of the illustration (b), corresponding to an inactive state of the exoskeleton, substantially no force moment is exerted on the upper modules. Of course, when the lower and upper modules are substantially aligned, i.e. when the user is not walking, but also not leaning down, the exoskeleton is also inactive.

This operation of the exoskeleton 100 is obtained by the fact that each lower module 210 and 310 includes a lever arm element 211, respectively 311, and an elastic member 212, respectively 312, as well as by the fact that the exoskeleton 100 includes a mechanical coupling element 110, connecting the lower and upper, right and left, modules.

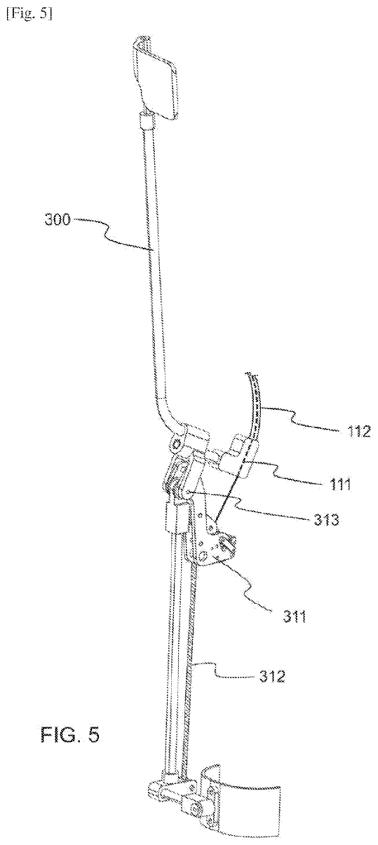

Next, reference will be made to the right upper 300 and right lower 310 modules, illustrated in [FIG. 5], it being understood that the same observations apply to the left upper 200 and left lower 210 modules.

More specifically, the lever arm element 311 is attached to the lower module 310 by a pivot connection about the pivot point 313, so that it could pivot freely relative to the lower module 310.

In particular, the lower module 310 includes a support structure in the form of a support rod, forming a support mast, connected by an upper end to the pivot point 313, and including at a lower end a means for connection to the lower limb 403 of the user.

In particular, the lever arm element 311 is a connecting rod including two ends, fastened to the pivot point 313 by a first end. For example, the first end of the connecting rod may include a yoke, in which the support rod of the lower module 310 fits.

In this aspect, the elastic actuator is an elastic member 312 extending between a lower end to which the lower limb of the user is attached, and the connecting rod forming the lever arm element 311, in particular at a second end of said connecting rod.

It should be understood though this arrangement that when the lever arm element 311 pivots away from the lower limb 403 of the user, the elastic member is tensioned. In this manner, in the active state of the exoskeleton, thanks to an elastic biasing force, a compensatory force moment about the pivot point 313 is exerted. This compensatory force moment tends to pivot the lever arm element towards the lower limb 403, which, for reasons that will be seen hereafter, tends to provide assistance to the user who tilts his/her trunk 401 forwards.

For example, the right upper module 300 is composed of a support rod 301 forming a support mast, extending along the trunk of the user, which includes a bent lower end. The bent lower end forms a substantially transverse arm, herein also forming a lever arm, on which a force can be exerted causing a moment tending to make the user straighten up when the exoskeleton 100 is in use. The support rod 301 is connected to the pivot point 313 at the elbow of the lower end, and includes at an upper end a means for connection to the trunk 401 of the user. For example, the lower end includes a yoke oriented towards the corresponding lower module 310, which accommodates an axis forming the pivot point 313, the connecting rod forming a lever arm 311 and the support rod of the lower module 310 being fitted onto said axis.

It should be understood that, thanks this arrangement, the upper module 300 and the lower module 310 can pivot freely relative to each other about the pivot point 313, and that the lever arm element 311 can pivot freely about this same point, relative to the two modules (it being understood that pivoting away from the lower limb 403 is limited by the elastic member 132)

The behaviour of the exoskeleton 100 disclosed further before is largely obtained by the presence of the mechanical coupling assembly 110, which attaches the lower modules 210 and 310 together, and also attaches them to the upper modules 200 and 300.

In particular, the mechanical connection between the lower modules 210 and 310 is done by means of an elongate, flexible connecting element 111, substantially with no elastic deformation capacity, which connects the ends of the lever arm elements 211 and 311, which are opposite to the pivot points 213 and 313. For example, such a connecting element 111 is a “Bowden” type steel cable.

Thus, when a tension is exerted on the connecting element 111, the lever arm elements 211 and 311 tend to pivot and tension the elastic members 212 and 312. It should be understood that the further the point of attachment of the connecting element 111 is from the pivot points 213 and 313, the longer the lever arm will be, and the more the elastic members 212 and 312 could be tensioned. In return, this means that with an equal biasing force exerted by the elastic member 212 and 312, the longer the lever arm, less tension on the connecting element 111 is necessary, which results in a longer service life of the exoskeleton.

The connection of the lower modules 210 and 310 to the upper modules 200 and 300 is done via a guide element 112 of the connecting element 111. The guide element 112 aims to couple the two upper modules to the two lower modules. In this manner, the mechanical coupling assembly 110 couples both the lower modules together via the connecting element 111, and the lower modules to the upper modules via the guide element 112. In other words, each of the connecting element 111 and the guide element 112 connects the lower, respectively upper, modules, but are not directly attached to each other, nonetheless the guide element 112 constrains movements of the connecting element 111, forcing it to move longitudinally in the guide element 112.

Thus, the combination of the mechanical connection of the lower modules together by the connecting element 111 and the guidance of the latter in the guide element 112 limits the free rotation of the lever arm elements 211 and 311. Indeed, the movement of the left lever arm element 211 causes the movement of the right lever arm element 311, and vice versa. Thus, the lever arm elements 211 and 311 can pivot freely in counter-phase. In particular, in the case where the connecting element 111 is a cable, with a constant length due to the absence of any elastic deformation capacity, the distance separating the two ends of a lever arm element 211 and 311 along the route of the cable remains identical for mechanical reasons. The guide element 112 ensures that the connecting element 111 generally follows the same route in all circumstances and avoids any uncontrolled deformation of the latter. To this end, it is useful to point out that the guide element 112 has some incompressibility, so as not to let itself be deformed under the action of the connecting element 111 which passes through it.

In the case where the connecting element 111 is a cable, the guide element 112 may be a sheath with a diameter adapted to accommodate said cable. Such a sheath is then relatively flexible and has enough flexibility to enable arrangement thereof on the exoskeleton, while being incompressible. Such sheaths per se are known in the art. The sheath is then fastened by a first end to the left upper module 200, and by a second end to the right upper module 300. Thus, the sheath being secured to the upper modules 200 and 300, any rotation of these relative to the lower modules 210 and 310 also causes a movement of the cable, via the sheath. The cable having a constant length, the latter pulls on the lever arm elements 211 and 311, which in turn tend to tension the elastic members 212 and 312. In this manner, when the upper modules 200 and 300 form substantially the same non-zero angle, with an identical sign, with respect to the lower modules 210 and 310, the lever arm elements 211 and 311 are blocked in rotation relative to the upper modules 200 and 300, the elastic members 212 and 312 are deformed and tensioned, causing the application of a compensatory force moment on the upper modules 200 and 300.

In particular, the sheath is fastened to the upper modules 200 and 300 at the lower end, and the cable and the sheath pass behind the back of the user in order not to hamper his/her movements.

An advantage of providing for a guide element 112 in the form of a sheath is to be able to guide the cable so as not to burden the user, in addition to improving resistance to wear, safety, etc. It is also possible to imagine a connecting element 11 that is different from a cable, such as a strap, a chain, and even a combination of flexible elements and rigid elements.

As an alternative, it is also possible to imagine a guide element 112 that is different from a sheath, such as simply two eyelets placed respectively on the lower ends of the upper modules 200 and 300, in which the cable passes, which would then need to be tensioned. Thus, the cable is attached to the upper modules 200 and 300, but is not protected and is not guided behind the back of the user. Nonetheless, such a solution just illustrates other possible variants, but does not have the advantages of a solution comprising a flexible guide element.

In view of the foregoing, it should be understood that the right portion formed by the modules 300 and 310 and the left portion formed by the modules 200 and 210 are attached by the coupling assembly 110, which is flexible. Thus, the exoskeleton 100 does not have a predefined width and can simply adapt to the morphology of the user wearing it.

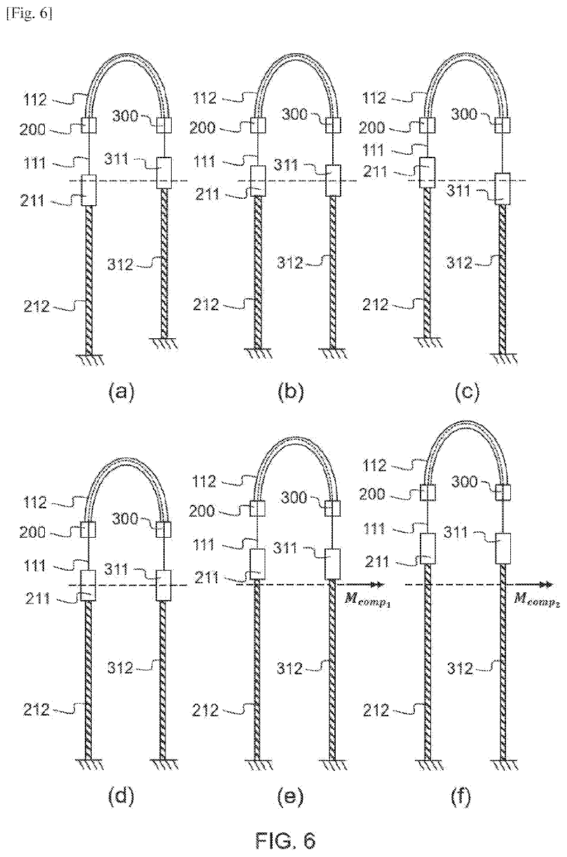

To sum up, [FIG. 6] schematically illustrates the above-described effects. The illustrations (a) to (c) illustrate a walking situation of the user, whereas the illustrations (d) to (f) show a situation in which the user leans forward at a more or less substantial angle. The exoskeleton is shown from behind, the cable forming the connecting element 111 being shown visible in dotted lines through the sheath forming the guide element 112.

In the illustration (a), the lower modules 210 and 310 pivot in counter-phase, schematically this could be summarised by an “upward” movement of the lever arm element of a first lower module, and a “downward” movement of the lever arm element of the other module. The connecting element 111 moves in the sheath accordingly, without changing its length. In the illustration (b), the lower modules 210 and 310 are in the same angular position, before continuing pivoting in counter-phase as illustrated in the illustration (c), which is the mirror of the illustration (a). During this movement, the elastic members 212 and 312 are not deformed and are not tensioned, the lever arm elements 211 and 311 as well as the elastic members 212 and 312 following the movement of the lower limbs.

In the illustration (d), the user is standing, at rest, the lower and upper modules are aligned. The elastic members 212 and 312 are not tensioned. In the illustration (e), the trunk 401 of the user is leaning slightly forwards, such that the lower and upper modules form substantially the same angle α₁. The elastic members 212 and 312 are then slightly deformed (they extend by a distance approximately equal to the sine of the angle α₁ multiplied by the length of a lever arm element, in the preferred aspect of this aspect. Other behaviours may be obtained by winding the connecting element 11 around a cam, a pulley, etc.), thereby being tensioned, and applying a compensatory force moment M_{comp}_{₁} on the upper modules. In the illustration (f), the user leans a little more, according to an angle α₂, and a compensatory force moment M_{comp}_{₂} on the upper modules is applied. One could notice that the elastic members 212 and 312 are stretched because the lower limbs are immobile, but that the lever arm elements 211 and 311 are pulled by the mechanical coupling assembly 110, which is attached to the upper modules 200 and 300.

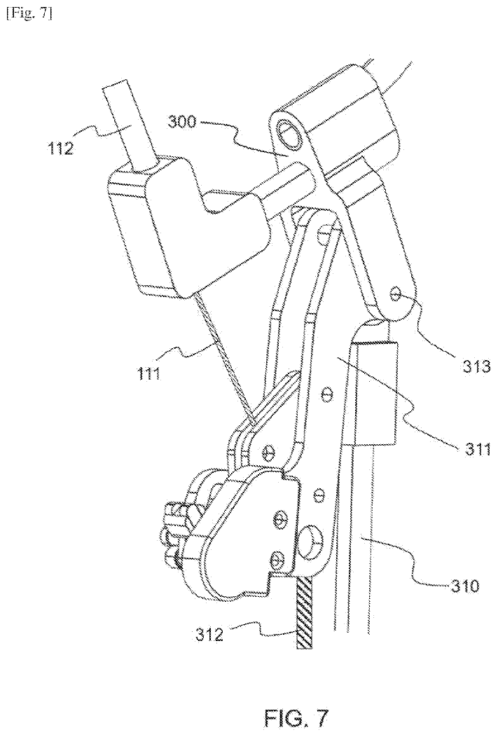

According to a preferred variant, the lever arm elements 211 and 311 are in the form of connecting rods formed of two plates arranged opposite one another, as shown in [FIG. 7], and comprise a device for declutching the assistance of the exoskeleton, carried out as follows.

A connecting rod 214, respectively 314, is pivotably arranged between the two plates. Such connecting rods 214 and 314 may also be formed of two plates arranged opposite one another and connected by holding axes. Reference is made again to the right side, the left side being substantially symmetrical to the right side.

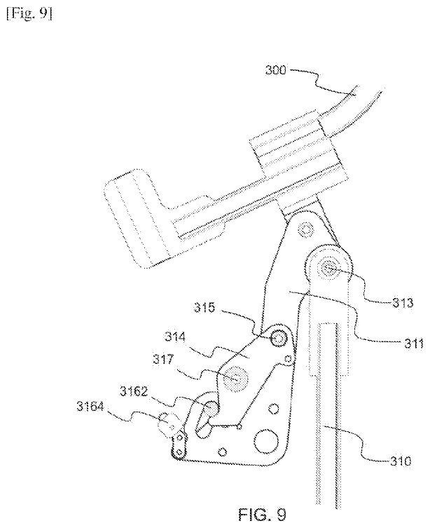

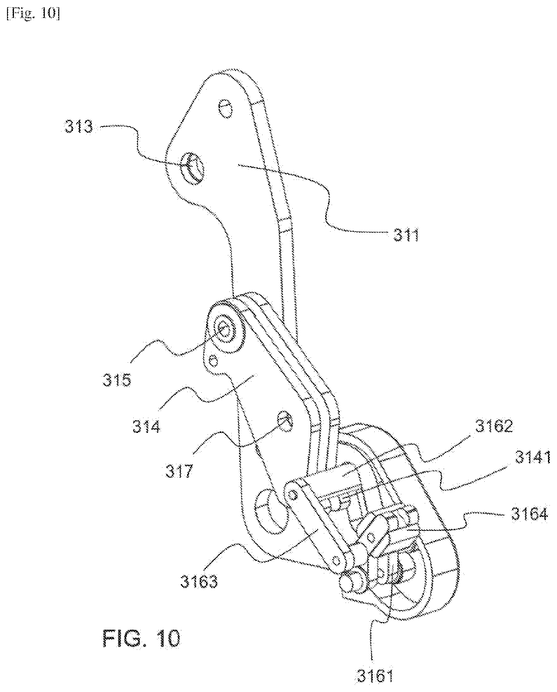

As shown in FIGS. 9 and 10, in which one of the two plates of the lever arm element 311 has been removed, the connecting rod 314 pivots about an axis 315, distinct from the pivot 313.

The connecting rod 314 is connected to the mechanical coupling assembly 110, more specifically to the connecting element 111 at a fastening point 317. The connecting rod 314 may be blocked or unblocked in rotation via a declutching latch 316.

For example, the declutching latch 316 may be in the form of a crank 3161 pivoting on the lever arm element 311, the rotation of which causes the translation of a blocking axis 3162 via a connecting rod 3163, the blocking axis 3162 being slidably guided in a groove of the lever arm element 311. The connecting rod 314 includes one end having a finger 3141 blocked by the blocking axis 3162 in a coupled state of the connecting rod 314 and the lever arm element 311. When the blocking axis 3162 starts translating, by actuation of the crank 3161, preferably featuring a joystick 3164 operable by the user, the blocking axis 3162 forces a slight rotation of the connecting rod 314 passing over the finger 3141, the connecting rod 314 and the lever arm element 311 then being in an uncoupled state. The connecting rod 314 can then pivot freely on the lever arm element 311, and the mechanical coupling assembly 110 is then no longer coupled to the lever arm element. In this manner, the elastic members 212 and 312 are not loaded, regardless of the movement of the user, the exoskeleton 100 thereby being inactivated.

Advantageously, one or more spring(s) is/are arranged on the lever arm element so as to be compressed, or tensioned, depending on the spring type, when the connecting rod 314 is blocked in rotation, thereby imparting a slight rotation of the connecting rod 314 when it is unblocked, so as to place the latter in an unblocking position distinct from the blocking position.

In order to easily switch the connecting rod 314 from the unblocked position into the blocked position, it is possible to provide for a strap connected to the connecting rod 314, on which the user can pull, locking the declutching latch 316.

According to a particular aspect, the upper portions 200 and 300 are attached to the user by means of a harness connecting the right 300 and left 200 upper modules. For example, such a harness may be U-shaped, with branches resting on the shoulders of the user, connected in the back of the user. In this manner, the harness rests on the shoulders and the top portion of the back of the user. Nonetheless, this harness is not intended to transmit significant forces, the user working against the upper modules, and vice versa, the upper modules thus being pressed against the trunk 401, without requiring any particular connection with the trunk. In other words, it would be enough for the upper ends of the upper modules 200 and 300 to rest on the trunk 401 of the user, for example via pads, nonetheless a harness as described before allows for a better hold, without any risk of movement of the exoskeleton, conferring a better safety on the system. Of course, the harness may be padded for more comfort. Also, it is possible to provide for a strap with a closing buckle, connecting the two upper modules from the front, as shown in FIGS. 1 to 3.

Similarly, at the lower ends of the lower modules 210 and 310, support pads and/or armbands or straps for connection to the lower limbs 402 and 403 may be provided, so that the lower modules 210 and 310 could follow the movement of the lower limbs 402 and 403.

Advantageously, the aforementioned transverse connecting element is in the form of a pelvic belt connected to the upper and lower modules at the pivot points 213 and 313. More specifically, the pelvic belt is connected to said modules by pivot connections coaxial with the pivot points 213 and 313, so as to follow the movements of the user, thereby increasing the comfort of use. Such a belt may be in the form of a strap, padded or not, provided with one or more closing and/or adjustment buckle(s), in order to adapt the exoskeleton 100 to different morphologies of users, in particular with regards to the waist circumference. Any other connecting element, other than a pelvic belt, may be considered, provided that it connects the right and left portions of the exoskeleton at the pivot points, and that it enables support, at least partial, of the exoskeleton at the waist of the user.

The use of textile straps, for the harness and the pelvic belt in particular, confers great flexibility on the exoskeleton 100, both in trunk torsion and in lateral bending.

Advantageously, the exoskeleton 100 has a means of adjusting the starting angle of the assistance. Such an adjustment means may be formed at the lower end of the upper modules 200 and 300. As shown in the figures, the end to which the connecting element 111 is fastened may be in the form of an endpiece in which the guide element 112 is accommodated, including a thread, the endpiece being screwed onto a tapped end of the rod forming an upper module. In this manner, the axial position of the endpiece may be varied, and more or less screwing/unscrewing the endpiece. This adjustment has the effect of varying the distance between the exit of the guide element 112 and the axis 317 (respectively 217 for the other side). The guide element 112 being substantially incompressible, the connecting element 111 is tensioned when the distance between the exit of the guide element 112 and the axis 317 increases.

Thus, when the endpiece is positioned so as to increase the distance between the exit of the guide element 112 and the axis 317, i.e. tension the connecting element 111, then the angle from which the assistance is triggered approaches zero, i.e. the assistance is triggered even during small amplitude movements. On the contrary, when the endpiece is positioned so as to minimise the distance between the exit of the guide element 112 and the axis 317, i.e. to relieve the connecting element 111, then the angle from which the assistance is triggered departs from zero, i.e. the assistance is triggered only during relatively large amplitude movements. In this manner, an adjustment of the starting angle of the assistance is obtained.

Finally, a means for adjusting the height of the exoskeleton 100 may be provided for. For example, such an adjustment means may be included at the upper modules 200 and 300. Instead of the rod forming the structure of these, it is possible to provide for an arrangement of rods sliding in tubes, allowing adjusting the height of the connection point of the exoskeleton with the trunk of the user.

It is not necessarily useful to provide for locking of this adjustment means, because it could be advantageous to let the rods slide freely when using the exoskeleton, thereby allowing compensating for deformations of the trunk of the user, in particular if the latter curves his/her back for example. It should be recalled that the exoskeleton 100 is advantageously attached to the trunk of the user via a harness, which therefore reduces any risk of unexpected shift of the exoskeleton on the trunk, allowing dispensing with of any locking device. Of course, such an optional member could nevertheless be provided for.

### Example of a Second Particular Aspect

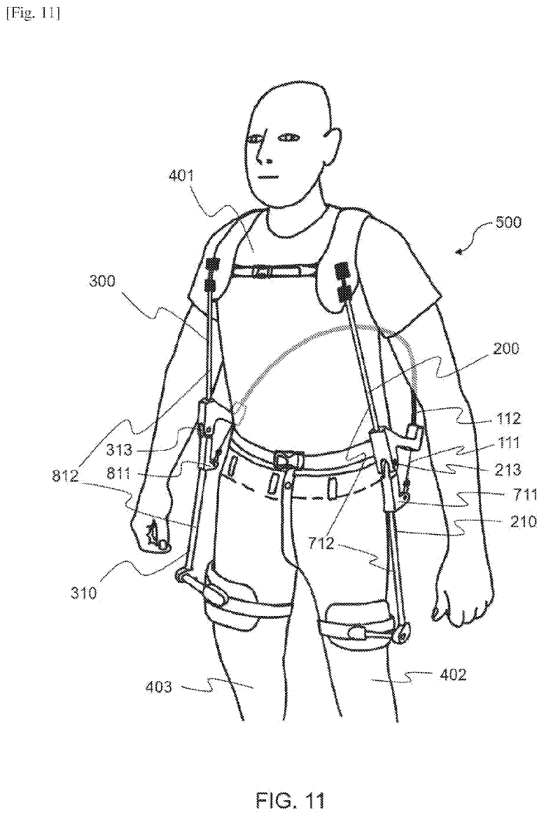

FIG. 11 shows a user wearing a trunk exoskeleton 500 according to a second aspect, in a rest state, in which the exoskeleton is in an “inactive” state and does not provide any assistance to the user.

The exoskeleton 500 of this second aspect has substantially the same structure as the exoskeleton 100 of the first aspect, that is why only the differences will be disclosed hereafter. In particular, the operation and the structure of the coupling assembly are substantially identical. Common or substantially identical elements bear the same references.

The upper modules 200 and 300 do not differ structurally from those of the exoskeleton 100, nonetheless the rods forming support masts have a flexibility conferring leaf spring type spring properties thereon, unlike the rods of the exoskeleton 100, which are substantially rigid.

The lower modules 210 and 310 primarily consist of rods forming support masts, as for the exoskeleton 100, these rods also having leaf spring type spring properties.

For example, the rods are made of a composite material such as fiberglass.

The lower modules 210 and 310 do not include a lever arm element, but an arm 711, respectively 811, projecting substantially transversely, at the end of which one end of the connecting element 111 is fastened, the connecting element thus directly connects the two lower modules. The projecting arm may be formed directly on the rod, or on an endpiece fastened on the rod. When the exoskeleton comprises a declutching device, the projecting arm may be locked in its projecting position, or declutched so as to be able to pivot freely. In other words, the projecting arm may be made in the form of a connecting rod pivotably arranged on the lower module, according to an aspect made mutatis mutandis from the declutching device of the previously-described first aspect.

The support masts of the upper modules 200 and 300 are attached to the pivot points at a lower end, but are not herein directly angled, since no lever arm is necessary. Only a transverse arm, formed for example on a yoke for fastening to the pivot point, herein serves as a fastening point for the guide element 112 at the lower end.

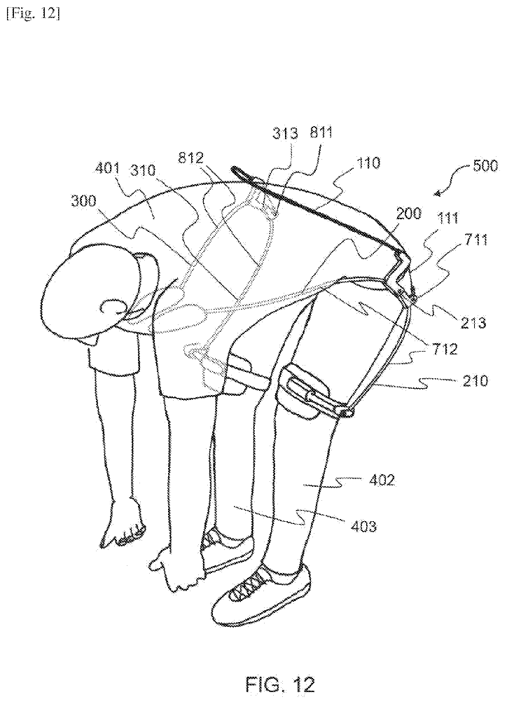

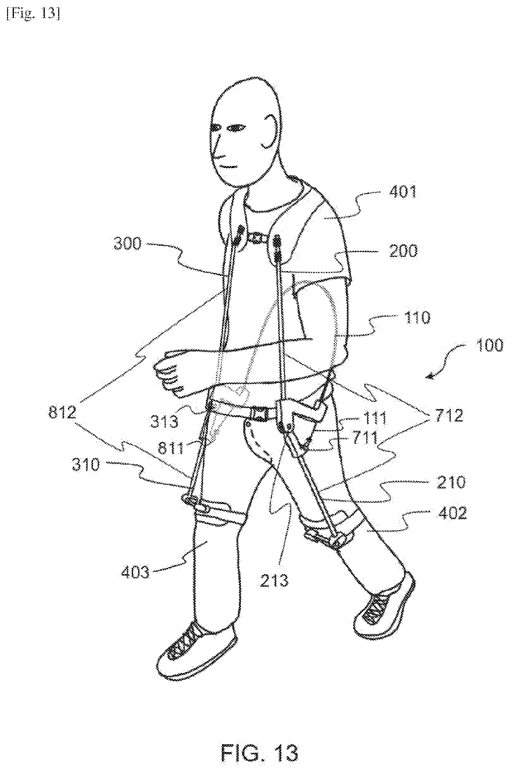

FIGS. 12 and 13 respectively illustrate the user in a working and walking posture.

In [FIG. 12], one could see that, in this second aspect, the rods of the upper 200 and 300 and lower 210 and 310 modules are folded and tensioned, and serve as leaf spring type springs. More specifically, each pair of upper module rod-lower module rod serves as a leaf spring type spring, the rods of such a pair being locked in rotation and behave like one single flexible long rod. In other words, this aspect comprises two elastic actuators 712 and 812 formed by the support masts of the upper and lower modules.

In [FIG. 13], it is visible that thanks to the cast assembly, the lower modules 210 and 310 may pivot freely in counter-phase, the rods of a pair of rods then behaving like two hinged elements, without being folded, the exoskeleton then providing substantially no assistance.

Moreover, all of the additional elements such as the pelvic belt, the harness or any other element described further upstream may be advantageously implemented on the exoskeleton 500.

Hence, it appears very clearly that in the context of the present disclosure, the coupling assembly preserves substantially the same structure and the same operation regardless of the selected type of elastic actuator, and regardless of its arrangement. The above-described preferred aspects present two alternatives of the disclosure, with two different types of structure and actuator arrangements, it being understood that any other actuator solution could be considered and is covered by the present disclosure.

What is claimed is:

1. A trunk exoskeleton including:
an upper portion able to be attached to the trunk of the user of the exoskeleton,
a pair of lower modules each being able to be attached to a lower limb of the user, each lower module being connected to the upper portion by a distinct pivot point located at the height of the hips of the user,
at least one elastic actuator configured, when tensioned, to exert a compensatory force moment on the trunk of the user,
a mechanical coupling assembly configured:
in a working posture of the user, to tension the at least one elastic actuator when the lower modules form substantially the same non-zero angle with the upper portion, the exoskeleton then providing assistance, and
in a walking posture of the user, to enable a counter-phase free pivoting of the lower modules, without the exoskeleton providing assistance,
characterised in that the coupling assembly includes:
a connecting element coupling the lower modules together,
a guide element of the connecting element, fastened to the upper portion, coupling the lower modules to the upper portion via the connecting element,
the connecting element and the guide element being flexible.

2. The exoskeleton according to claim 1, wherein said flexible connecting element is an elongate element having substantially no elastic deformation capacity, and wherein said flexible guide element is a substantially incompressible elongate element.

3. The exoskeleton according to claim 2, wherein said flexible connecting element is a cable, and wherein the flexible guide element is a sheath with a diameter adapted to accommodate said cable.

4. The exoskeleton according to claim 1, wherein the upper portion comprises a pair of support masts, each support mast including on a lower end a fastening point of said guide element, and being connected to said corresponding pivot point at said lower end, and having at an upper end a means for connection to the trunk of the user.

5. The exoskeleton according to claim 1, wherein the exoskeleton further includes a pelvic belt fastened at said pivot points.

6. The exoskeleton according to claim 1, wherein the upper portion is formed of two independent upper modules coupled by said guide element.

7. The exoskeleton according to claim 6, wherein said upper modules are attached to the trunk of the user by means of a harness connecting the independent upper modules, the harness being U-shaped, the branches of which rest on the shoulders of the user and are connected in the back of the user.

8. The exoskeleton of claim 1, each lower module including an elastic actuator, and wherein each lower module comprises:
a support mast connected by an upper end to said pivot point, and including at a lower end a means for connection to a lower limb of the user,
a lever arm element pivotably mounted on said pivot point by a first end, and a second end of which is connected to the connecting element, and
said elastic actuator of a lower module being a member loaded in tension, extending between the second end of the lever arm element and the lower end of said support mast of the lower module.

9. The exoskeleton according to claim 8, wherein the elastic member of a lower module is selected from among: an elastic cable, an elastic strap, a coil spring, a gas spring, a hydraulic spring.

10. The exoskeleton according to claim 1 and claim 4, including two elastic actuators, wherein:
each lower module comprises a support mast connected by an upper end to said pivot point, and including at a lower end a means for connection to a lower limb of the user,
each end of the connecting element directly connects the support mast of a lower module,
and wherein each lower module support mast-lower module support mast pair forms an elastic actuator loaded in bending in said working posture.

11. The exoskeleton according to claim 10, wherein said support masts of the lower and upper modules consist of flexible rods made of a composite material.

12. The exoskeleton according to claim 1, further including at least one declutching device, configured to couple/uncouple a lower module of the mechanical coupling assembly.

13. The exoskeleton according to claim 12, wherein said declutching device includes:
a connecting rod pivotably arranged on said lower module, said connecting rod being connected to the connecting element, and
a declutching latch, allowing blocking or unblocking the pivoting of said connecting rod relative to the lower module,
so as to couple or uncouple said mechanical coupling assembly from said lower module.

14. The exoskeleton according to claim 1, wherein the guide element is compressible, and forms an elastic actuator loaded in compression in said working posture.
